(19) United States
(12) Patent Application Publication
(10) Pub. No.: US 2016/0063077 A1
(43) Pub. Date: Mar. 3, 2016

(54) DATA BROKERING SYSTEM FOR FULFILLING DATA REQUESTS TO MULTIPLE DATA PROVIDERS

(71) Applicant: CAMBRIAL SYSTEMS LTD., Ontario (CA)

(72) Inventors: Craik Pyke, Ontario (CA); Abraham Wehbi, Ontario (CA); Ray Ouellette, Ontario (CA); Brian Forbes, Ontario (CA); Jorge Morales, Ontario (CA)

(21) Appl. No.: 14/473,345

(22) Filed: Aug. 29, 2014

(51) Int. Cl. G06F 17/30

(52) U.S. Cl. CPC G06F 17/30563; G06F 17/30289; G06F 17/30386

(57) ABSTRACT

A data broker system is described that allows multiple different systems to interoperate with each other. The data broker system provides a consistent data model of data provided by different system. Data clients can request data from the data broker system without requiring details on the different data systems that are responsible for providing the data.

### TECHNICAL FIELD

The current description relates to data brokering, and in particular to providing data brokering access between different networked data provider systems.

### BACKGROUND

As the number of networkable devices or data providers that can collect data and generate data grows the ability to retrieve and process the data in a meaningful manner becomes more complex. A data request may require data to be retrieved by multiple disparate information systems provided by computing devices or computing systems. Many industries such as the medical field may utilize many different information systems provided by computing systems or computing devices utilizing different data formats where data to fulfill a data request or query. For example, a human resources information system may provide information about employee allocation, their assigned location within the hospital and their contact information. A building information system may provide information about the building, such as heating, cooling and ventilation of different rooms, what doors are open, closed and/or locked and the location of elevators. A patient information system may provide information about patients of the hospital, such as personal information, insurance information, medical procedures, patient status information, monitoring equipment information and a patient identifier. For example, a bed may be associated with a particular patient, and the bed may be associated with monitoring equipment or computing devices such as a heart rate sensor, a blood pressure sensor, and position sensors of the bed itself. Although there is substantial information available from various computing systems, each system is separate and typically does not interact with other systems.

Therefore there is a need to provide a system and method to facilitate accessing data provided from disparate computing systems and computing devices.

### BRIEF DESCRIPTION OF THE DRAWINGS

Features, aspects and advantages of the present disclosure will become better understood with regard to the following description and accompanying drawings in which:

FIG. 1 depicts an environment in which a data broker in accordance with the present disclosure may be provided;

FIG. 2 depicts components of a data brokering system;

FIG. 3 depicts components of a high-availability data brokering system;

FIG. 4 depicts data providers within a hospital environment that provide data;

FIG. 5 depicts models of data provided by different data providers;

FIG. 6 depicts a combined model of the data provided by the different data providers;

FIG. 7 depicts a simplified view of the data model of FIG. 6;

FIG. 8 depicts a process of brokering data between different data providers;

FIG. 9 depicts a process of brokering data between different data providers;

FIG. 10 depicts a process for subscribing to data; and

FIG. 11 depicts a method of brokering data exchange between a plurality of data providers.

### DETAILED DESCRIPTION

In accordance with the present disclosure there is provided a method of brokering data comprising receiving a data request message at a data broker system communicatively coupled to a plurality of data providers, the data request message comprising a data indicator specifying desired data and at least one given parameter for use in retrieving the desired data; accessing a data model of data provided by the plurality of data providers, the data model describing: available data definitions specifying data provided by each of the plurality of data providers; data request definitions for retrieving available data from the plurality of data providers, each data request definition specifying at least one required parameter for fulfilling a data request by associated with the respective data request definition; and one or more data transformation definitions specifying transformations between respective available data definitions of different data providers for corresponding data; and determining from the data model a chain of data requests to one or more data providers of the plurality of data providers to provide the desired data based on the at least one given parameter.

In an embodiment, the method further comprises requesting the desired data according to the determined chain of data requests; receiving the desired data from at least one of the plurality of data providers; and formatting and returning the desired data in response to the received data request message.

In a further embodiment of the method, one or more of the available data definitions comprise a unique data identifier associated with the data provided by the respective data provider.

In a further embodiment of the method, one or more of the available data definitions further comprise: a type description describing a variable type of the associated data provided by the data provider; a description of the associated data provided by the respective data provider; and one or more restrictions on the associated data.

In a further embodiment of the method, one or more of data request definitions comprise: a unique operation identifier; an input data definition of at least one available data definition that the respective data request requires as the required parameter; and an output data definition of at least one available data definition that the respective data request returns.

In a further embodiment of the method, one or more of the data transformations comprise: an identification of two or more available data definitions associated with the corresponding data; and a mapping between the two or more the two or more available data definitions.

In a further embodiment of the method, the data indicator of the received data request message comprises an identifier of at least one available data definition in the data model.

In a further embodiment of the method, the chain of data requests comprises a plurality of data request definitions from the data model, with a first data request definition of the plurality of data request definitions comprising a data request definition having the at least one required parameter corresponding to the at least one given parameter of the received data request message, and a second data request definition of the plurality of data request definitions comprising a data request definition for retrieving available data corresponding to the desired data specified by the data indicator of the received data request message.

In a further embodiment of the method, the chain of data requests further comprises a plurality of linking request definitions with retrieved available data of one of the plurality of additional request definitions providing one or more required parameters of a subsequent additional request definition.

In a further embodiment of the method, the chain of data requests comprises a plurality of data request definitions, with the at least one required parameter of one of the plurality of data request definitions provided by retrieved available data by a second one of the plurality of data request definitions, at least one or more of the data transformation definitions providing a mapping between the at least one required parameter of the one of the plurality of data request definitions provided by the retrieved available data by the second one of the plurality of data request definitions.

In a further embodiment of the method, the chain of data requests to provide the desired data based on the at least one given parameter is determined recursively.

In a further embodiment of the method, the data request message is a subscription request message for the desired data, the method further comprising subscribing to the desired data provided by the data provider.

In a further embodiment of the method, the data broker system comprises a plurality of data engine delegates each comprising a respective copy of the data model, the method further comprising: determining a data engine delegate of the plurality of data engine delegates for processing of the received data request message; and passing the received data request message to the determined data engine delegate.

In a further embodiment, the method further comprises creating a periodic trigger for polling the desired data requested in the subscription request message.

In a further embodiment, the method further comprises receiving a registration message from a data provider for registering available data and data requests for retrieving the available data

In a further embodiment, the method further comprises adding the available data and data requests from the registration message to the data model.

In a further embodiment, the method further comprises identifying at least two available data definitions of corresponding data from the data model; and creating a data transformation linking the at least two available data definitions.

In a further embodiment, the method further comprises providing an indication to one or more data consumers coupled to the data broker system that the data model has been updated.

In accordance with the disclosure there is further provided data broker system for brokering data exchange between a plurality of data providers communicatively coupled to the data broker system, the system comprising: a memory unit for storing instructions; and a processing unit configured for executing the instructions, which when executed configure the system to: receive a data request message at a data broker system communicatively coupled to a plurality of data providers, the data request message comprising a data indicator specifying desired data and at least one given parameter for use in retrieving the desired data; access a data model of data provided by the plurality of data providers, the data model describing: available data definitions specifying data provided by each of the plurality of data providers; data request definitions for retrieving available data from the plurality of data providers, each data request definition specifying at least one required parameter for fulfilling a data request by associated with the respective data request definition; and one or more data transformation definitions specifying transformations between respective available data definitions of different data providers for corresponding data; and determine from the data model a chain of data requests to one or more data providers of the plurality of data providers to provide the desired data based on the at least one given parameter

In a further embodiment of the data broker system, the executed instructions further configure the data broker system to: request the desired data according to the determined chain of data requests; receive the desired data from at least one of the plurality of data providers; and format and returning the desired data in response to the received data request message.

In a further embodiment of the data broker system, one or more of the available data definitions comprise a unique data identifier associated with the data provided by the respective data provider.

In a further embodiment of the data broker system, one or more of the available data definitions further comprise: a type description describing a variable type of the associated data provided by the data provider; a description of the associated data provided by the respective data provider; and one or more restrictions on the associated data.

In a further embodiment of the data broker system, one or more of data request definitions comprise: a unique operation identifier; an input data definition of at least one available data definition that the respective data request requires as the required parameter; and an output data definition of at least one available data definition that the respective data request returns.

In a further embodiment of the data broker system, one or more of the data transformations comprise: an identification of two or more available data definitions associated with the corresponding data; and a mapping between the two or more the two or more available data definitions.

In a further embodiment of the data broker system, the data indicator of the received data request message comprises an identifier of at least one available data definition in the data model.

In a further embodiment of the data broker system, the chain of data requests comprises a plurality of data request definitions from the data model, with a first data request definition of the plurality of data request definitions comprising a data request definition having the at least one required parameter corresponding to the at least one given parameter of the received data request message, and a second data request definition of the plurality of data request definitions comprising a data request definition for retrieving available data corresponding to the desired data specified by the data indicator of the received data request message.

In a further embodiment of the data broker system, the chain of data requests further comprises a plurality of linking request definitions with retrieved available data of one of the plurality of linking request definitions providing one or more required parameters of a subsequent linking request definition.

In a further embodiment of the data broker system, the chain of data requests comprises a plurality of data request definitions, with the at least one required parameter of one of the plurality of data request definitions provided by retrieved available data by a second one of the plurality of data request definitions, at least one or more of the data transformation definitions providing a mapping between the at least one required parameter of the one of the plurality of data request definitions provided by the retrieved available data by the second one of the plurality of data request definitions.

In a further embodiment of the data broker system, the chain of data requests to provide the desired data based on the at least one given parameter is determined recursively.

In a further embodiment of the data broker system, the data request message is a subscription request message for the desired data, and wherein the executed instructions further configure the data broker system to subscribe to the desired data provided by the data provider.

In a further embodiment of the data broker system, the data broker system further comprises a plurality of data engine delegates each comprising a respective copy of the data model, the executed instructions further configure the data broker system to: determine a data engine delegate of the plurality of data engine delegates for processing of the received data request message; and pass the received data request message to the determined data engine delegate.

In a further embodiment of the data broker system, the executed instructions further configure the data broker system to create a periodic trigger for polling the desired data requested in the subscription request message.

In a further embodiment of the data broker system, the executed instructions further configure the data broker system to receive a registration message from a data provider for registering available data and data requests for retrieving the available data

In a further embodiment of the data broker system, the executed instructions further configure the data broker system to add the available data and data requests from the registration message to the data model.

In a further embodiment of the data broker system, the executed instructions further configure the data broker system to identify at least two available data definitions of corresponding data from the data model; and creating a data transformation linking the at least two available data definitions.

In a further embodiment of the data broker system, the executed instructions further configure the data broker system to provide an indication to one or more data consumers coupled to the data broker system that the data model has been updated.

In order to fulfill and inquiry data may be available from numerous different networked data providers or information systems. The data provided by each of the data providers can be more useful when they can be presented in context of the system as a whole. Each data provider may not inherently have the ability to communicate with other data providers or information systems to retrieve the information and parameters or data formats may not be consistent. In order to access the data, an application may utilize an application programming interface (API) or similarly well defined interface in order to request and receive the data. The request for data may be made using different techniques, including synchronous requests, asynchronous requests, and/or pub/sub models. An application that accesses data from different systems may be required to use multiple different APIs or different techniques for accessing the data, which can make the development of the application more difficult.

As described further herein, a data broker system may provide access to data from multiple different data providers allowing an application to request and receive data without having to be aware of the different systems actually providing the data, or the interfaces required for accessing them. A data broker system as described further herein allows multiple different data providers to register with the data broker in order to provide access to the available data. A data consumer may access the available data from the data broker. Further, the data broker is able to link together corresponding data provided by different systems, allowing data requests to be fulfilled by multiple systems. That is, the data broker may chain requests to networked data providing systems in order to satisfy a data request that cannot be satisfied by a single data providing system.

Although the data provided by the different data providers differs, it may be inter-related based upon inferred direct and/or indirect relationships of parameters to a requested data object. The inter-relation between the different data provided by the data providers may be determined based on a metadata model definition within the platform. For example, in a hospital environment there may be numerous different data provider systems including, for example, patient information systems, monitoring systems that provide sensor information of patients, human resources information systems of hospital employees, etc. Although the data provided by each of these systems is different, there may be corresponding data in two or more systems. For example, a patient's name may be maintained in the patient information system along with other information, such as a room and bed assignment of the patient in the hospital. The monitoring system may provide data from sensors, such as heart rate sensors, that are associated with a particular bed. The employee information system may maintain information on the staff responsible for cleaning a particular floor or location as well as a doctor responsible for a floor or room. In addition to providing a single point of access to satisfy a data query, the data broker can also facilitate data requests across the multiple systems without the original data query requiring knowledge of all the individual systems required to satisfy the query. For example, an application may wish to identify the staff responsible for a particular patient's, the location of the patient and medical information associated with the patient from the data broker. No single system can fulfill the request. The patient information system stores information pertaining to John Smith; however, it does not store any information regarding a particular staff that is working and responsible for John Smith's room. Similarly, the human resources (HR) system may store information about the particular employee currently responsible for maintaining a particular room or location; however the HR system does not maintain any information about the patient in a particular room. Additionally, the patient medical records or current monitor information may be provided by separate systems. The data broker system may receive the request, which cannot be satisfied by a single system, and determine how to provide the desired data, if possible. For example, the data broker may determine that in order for the HR system to provide the staff responsible for the patient it is necessary to provide a particular room, and that a particular room may be provided by the patient information system given a patient's name. Accordingly, the data broker requests the room number for the patient John Smith, and then requests the staff responsible for the returned room number. In addition certain data providers such as medical devices may be associated with a location and/or a patent identifier and may only provide data or track data related to their particular function. The interconnection between the data may not be associated by the data provider devices but may require multiple systems to build associations between data to service data requests.

The above example is intended to provide an overview of the inter-relation of different data systems. The described systems have been contrived in order to more clearly describe the possible relationships of data between different systems. Further, although the above example has been described in relation to a hospital environment, the data broker described herein may be used in and across various different fields in which data is provided by data providers systems which are not directly inter-operable and can use different data formats or parameters for collecting and storing data.

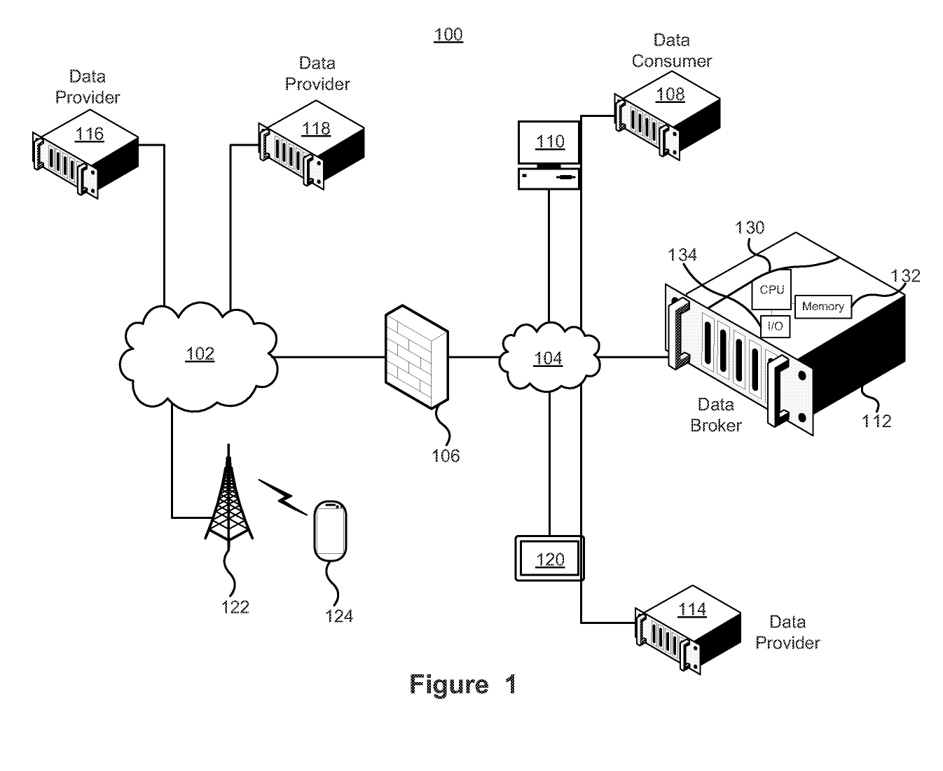

FIG. 1 depicts an environment in which a data broker in accordance with the present disclosure may be provided. The environment 100 comprises a number of connected computing systems. The computing systems may be connected by a number of inter connected networks, including both public networks such as the Internet 102 as well as private networks 104. The private networks 104 may be connected to other networks through one or more firewalls 106. It will be appreciated that the public and private networks 102, 104 may use various different communication techniques for transmitting information between connected components.

The private network 104 may include one or more computer systems that may co-operate to provide various functions to users. For example, as described above, the private network 104 may be provided in a hospital environment and the computer systems may provide various functionality, such as patient tracking, HR management, data collection, image storage, sensor information, resource management, resource or supply tracking etc. The private network 104 includes a data consumer 108 that can consume data or data objects from one or more sources. The data consumer provides some desirable functionality using the consumed data. The data consumer 108 may provide access to the consumed data to users, may process the data, perform calculations using the data, analyze the data, and display the data and/or information based the information provided in the data object.

As an example, the data consumer 108 may provide a patient information system that retrieves data from a patient database and presents it to a user. The data consumer 108 may provide access to information through one or more user terminals such as computer 110 within the private network. This functionality may be referred to as a “ward board” in a hospital setting. The ward board may provide relevant information on patients in the ward. The information required is not present in one system and requires data from multiple systems or data providers in order to be presented. The patient information displayed on the ward board may be retrieved by the data consumer providing the ward board functionality from the data broker. The data broker may request data from multiple data providers in order to provide all of the patient information that is required.

The private network may also comprise the data broker system 112, which as described further below, facilitates data exchange between different systems. Although depicted as being located within the private network, it is possible for the data broker to be located within a public network. For example, the data consumer 108 may retrieve information from the data broker 112 instead of the data source directly. As described further, the data broker 112 allows data consumers to more easily make use of available data from multiple different data providers without having to be aware of each specific interface for interacting with the data providers. The data broker 112 comprises at least a processor 130, a memory 132 for storing instructions to perform data brokering functionality and a networking interface 134 for interacting with data consumers and data providers.

The data broker 112 provides data to one or more data consuming applications, such as data consumer 108. The data broker 112 retrieves data from one or more data providers, such as data provider 114. The data provider 114 is depicted as being located within the private network 104; however, it is possible for the data broker 112 to retrieve data from one or more data providers located outside of the private network. For example, data providers 116, 118 are connected to the network 102, through the firewall 106 to the private network 104 and the data broker 112. In addition to retrieving data from local and externally located data providers, the data broker 112 may provide data from multiple data providers to different data consumers. Although only a single data consumer 108 is depicted in FIG. 1, however the data broker 112 may provide data to a plurality of data consumers, including data consumers located within both the private network 104 and the public network 102.

The data consumer 108 may provide access to data using one or more user computers, tablets, cellular phones, smartphones, or computing devices, for example a user computer 110 or a tablet 120 located on the internal network 104. The data consumer 108 may also be located on the public network 102, or through other networks, such as a cellular network 122 for connecting to a cellular phone 124.

As depicted with regard to FIG. 1, various components, such as data consumers, data providers and the data broker may be provided by one or more physical computing devices. Although depicted as being provided on respective physical servers, it will be appreciated that a particular component may be provided by a combination of a plurality of servers, for example to provide redundancy or scalability. Additionally or alternatively, a plurality of the components may be provided on the same physical server or servers. The data consumers, data providers and the data broker can comprise one or more processors and associated memory for storing instructions for storing, retrieving and communicating data between the devices. Certain functions may be distributed between devices or data may be stored in one or more network data storage devices.

Each data provider 114, 116, 118 may register with the data broker 112. When registering with the data broker 112, a data provider provides information to the data broker 112 pertaining to the data that is available from each data provider as well as information on how that information may be accessed. When a data provider registers with the data broker, it provides a definition of the data that is available and the data broker uses the information to build a model of available data and transformation definitions required to access the data between data providers. The data broker's data model provides an ontology that describes all of the data available from the different registered data providers as well as information for accessing the available data.

The ontology provides a common data definition for the available data. Different data providers may refer to corresponding data using different identifiers. For example one data provider may refer to a patient's name using the identifier “PatientName” while another data provider refers to the same patient's name using the identifier “PName”. In addition to providing a common data definition for corresponding data, the ontology may also provide an indication of data translations between different systems. That is, the ontology may indicate that particular pieces of data in different systems correspond to one another, although referred to differently by different systems. The data broker may use this information in order to link requests between the different systems. For example, a request to one system may return PatientName, which could be used as PName in a request to another system. The ontology information may also include information for use translating corresponding data from one format to another. For example, one data provider data definition may refer to the patient's name using the identifier PatientName and it may have a format of FirstName, LastName, while another data provider uses the identifier PName for the patient's name, which has the format of LastName, FirstName. The translation information in the ontology provided by the data model allows translation of data between the different systems and formats.

Once one or more of the data providers are registered with the data broker 112, a data consumer 108 may request the available data from the data broker 112. As a simple example, if data provider 114 can provide a patient's name associated with a specified patient identifier, the data consumer 108 may request the patient name from the data broker 112 by supplying a patient identifier in a request message. The data broker 112 would receive the request, determine how to fulfill the request according to the data model and then generate requests to one or more data providers in order to fulfill the data request message. Once received, the data broker 112 engine may re-format the data and return it in response to the request. The data consumer 108 does not need to be aware of the specific data provider that provides the requested patient name, or how the data is accessed. Instead, the data consumer 108 simply requests the desired data from the data broker and the data broker determines how to fulfill the request. The data consumer may request the data model or portion thereof from the data broker in order to determine what data is available from the different systems. However, the data consumer simply needs the information on what data is available. It is not necessary for the data consumer to be aware of what data provider actually provides the data or the particulars of the interface of the data provider for accessing the data.

The data broker 112 determines how to provide requested data. In the above example, it is trivial for the data broker 112 to determine how to provide the requested data. The data broker 112 determines the data provider 114 that provides the patient's name and since the request provides the parameter, namely the patient identifier required by the data provider, the request can be fulfilled by a single data provider. However; the data broker 112 may chain together requests to different data providers in order to fulfill a single request. Accordingly, the data consumer 110 120 may send a data request from the data broker that cannot be satisfied by a single data provider. As an example, one data provider may provide a patient's name given a patient identifier, or a patient identifier given a patient's name. A second data provider may provide information about the room and bed a patient is located in based on a patient identifier. The data consumer does not need to be aware of what data is provided by the different data providers. Rather, the data consumer is simply aware of the data available from the data broker, which may be achieved through receiving the data model or portion thereof. The data consumer may request the desired data, for example what bed a patient is in and provides the available information, which in this example is the patient's name. The data broker receives the request and determines how to fulfill the request. The data broker uses the data model to determine what parameters are required when requesting the bed information from the data provider such as the data format, request formation and have to map between data. In this example, the data broker determines from the data model that one data provider can provide the requested bed information but requires a patient identifier, which was not provided in the data consumer's request. The data broker determines if the patient identifier can be determined from the available data described in the data model. The data broker determines that another data provider can provide the patient identifier given a patient name, which was provided in the request. Accordingly, the data broker retrieves the patient identifier given the patient's name, and then retrieves the bed information using the patient identifier. The bed information may then be returned to the data consumer in response to the request. The order in that the data requests are generated to the data providers is provided as a chain of requests as defined in the data model to ensure that the data request message can be fulfilled appropriately.

In the above example, the data broker is able to determine how to satisfy the request. However, it may not always be possible to satisfy a given request, in which case the data broker may inform the data consumer that the request could not be fulfilled, which may specify why the request could not be satisfied. Further, the above example has assumed that a single patient identifier is returned for a given patient name. However, it is possible that different patients will share the same name, and hence multiple patient identifiers may be associated with the same patient name. The data broker may retrieve and return bed information for each of the returned patient identifiers, or only a single one, for example the first. If not all of the results are returned, the data broker may include an indication that further results are available. Further, it is possible for the request to further specify parameters in order to narrow down the number of results. For example, the data consumer may request bed information for a patient name as well as a date or date range the patient was admitted.

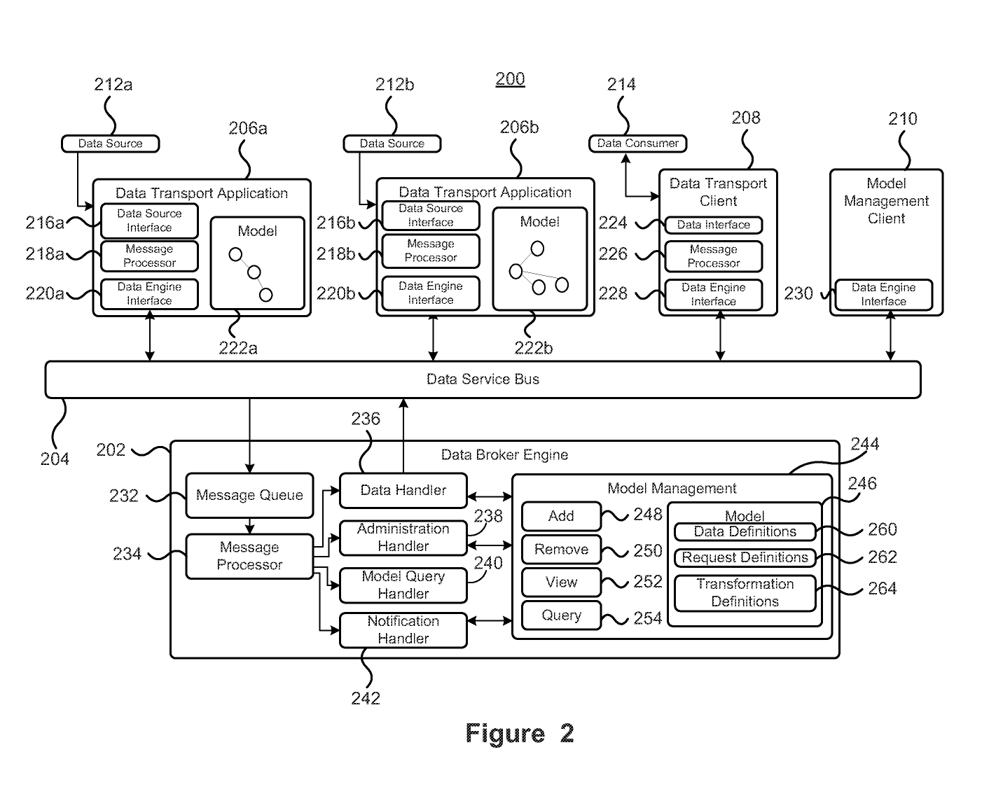

FIG. 2 depicts logical components of a data brokering system. The logical components depicted in FIG. 2 may be provided by a number of computing systems each comprising at least a memory storing instructions and a processor executing instructions to configure the respective computing system to provide one or more of the logical components.

The data brokering system 200 comprises a data broker engine 202 that may communicate with other components using a data service bus 204. The data service bus 204 allows messages to be communicated between the individual components. The service bus 204 provides functionality for interconnecting a number of components and can perform message routing between components, protocol transformation if required as well as providing security functionality for the communication. Various service bus architectures exist that may be used for the data service bus 204. One example of a service bus is MuleESB provided by MuleSoft™.

The data broker 202 can retrieve data from one or more data transport applications 206a, 206b (referred to collectively as data transport applications 206) using the data service bus 204. The data transport applications 206 provide an interface to the data broker engine 202. Each data transport application may act as an intermediary between a data source and the data broker engine. The functionality of a data transport application may be incorporated into the functionality of the data source. Alternatively, the data transport application may alternatively be separate from the data source functionality. For example, data transport applications may be created to provide an interface to a legacy or existing data source.

Each data transport application 206 may include data source interfaces 216a, 216b (referred to collectively as data interfaces 216) for interfacing with a respective data source 212a, 212b (referred to collectively as data sources 212). The data source interfaces 216a, 216b allow the data transport application to retrieve data from the data source 212a, 212b. If the data transport application is incorporated into the data source, the data source interface may be omitted or may be implemented within the data source. The data source interfaces 216 may implement an interface defined by the particular data source 212 in order to be able to retrieve data. For example, data source 212a may expose an application programming interface (API) through remote procedure calls (RPC) over simple object access protocol (SOAP). Accordingly, data source interface 216a would implement the RPC calls using SOAP in order to request and receive data from the data source 212a. Data source 212b may expose access to the available data through a proprietary API using, for example transmission control protocol (TCP). Accordingly, the data source interface 216b may implement the proprietary API in order to access the available data provided by data source 212b.

Each of the data transport applications 206 may also include a data broker engine interface 220a, 220b (referred to collectively as data broker engine interfaces 220) that allows the data transport applications 220 to communicate with the data broker engine 202. The data engine interfaces 220 can be implemented using various technologies depending upon the architecture of the data service bus. For example, the data engine interfaces 220 may be implemented using a messaging architecture, where communication between the data transport applications 220 and the data broker engine 202 is accomplished by passing messages. The data engine interfaces 220 may use messaging functionality supported by the data service bus 204. For example, if the data service bus 204 uses MuleESB, the messaging of the data engine interfaces may be provided by a messaging service such as ActiveMQ™ provided by Apache Software Foundation™.

Although specific technologies are described with regard to the implementation of the data service bus 204 and data engine interfaces 220, other implementations may be used. Further, these implementations, or other similar technologies, may provide a simple means of providing a robust system design, which may include a number of considerations that may be extraneous to the data broker system described herein. Accordingly, although the use of these technologies may simplify the implementation of the overall system, their use is not required.

The data transport applications 206 may also comprise a message processor 218a, 218b (referred to collectively as message processors 218). The message processors process messages received from the data broker engine. Generally, the messages are requests for data from the data transport applications 206. However, the messages may include other messages including administration messages, control messages as well as messages from the respective data sources 212.

Each of the data transport applications 206 may also have a model 222a, 222b (referred to collectively as models 222) of the available data from the data provider as well as operations provided by the data providers. For example, a data provider may store two pieces of associated data, namely Data1, Data2 and can provide Data2 in response to a request with Data1 as a parameter. A depiction of the model for such a data provider is provided in the following:
Available Data:
   Data1: dataURI1
      Type: Type definition
      Restrictions: Restriction definition
      Description: Description of Data1
   Data2: dataURI2
      Type: Type definition
      Restrictions: Restriction definition
      Description: Description of Data2
Operations:
   Operation1: operationURI1
      Input: dataURI1
      Output: dataURI2
      Type: GET
      Description: Description of Operation1

As depicted above, a model may define the data available, as well as operations for accessing the data. The above model defines an operation, ‘Operation1’ that requires an input parameter of a first data type Data1 and returns a second data type Data2.

The operation is a GET type operation, which may be performed, for example by sending a hypertext transfer protocol (HTTP) GET request to the operationURI1 defined in the model. The GET request should include the input data, namely a value for Data1. When the data provider receives the GET request at the operationURI1 it retrieves the Data2 associated with the provided Data1 value and returns the retrieved data in a response message. The model may specify a uniform resource identifier (URI) for each definition of the available data and operation. Each data definition may specify a type of the data, which may be for example a basic type such as integer, float, string, character, etc; or the type may define a complex type composed of a plurality of data types. The data definition in the model may specify restrictions on the data. The restrictions may specify restrictions on the values of the data, for example the value must be positive. Additionally, or alternatively, the restrictions may specify restrictions on accessing the data, such as users or groups of users that are allowed to access the data or are prohibited from accessing the data. The model may also provide a description of the data. The description may provide a brief human-readable description of the data.

The model may also define one or more operations that the data provider can perform. Each operation may be associated with a unique URI. The definition of the operation may specify input parameters required for by the operation and output parameters provided by the operation. The input and output parameters may specify one or more of the data types of the model using the data's URI. The operation may also define a type of the operation, such as whether it creates, reads, updates or deletes data. The operation may be implemented by the data transport application by passing HTTP messages to the operation URI, and the type may define the HTTP request type such as GET, POST, PUT, and DELETE.

A data consumer 214 may interface with the data broker engine 202 using a data transport client 208. Although depicted as being separate from the data consumer 214, it is possible for the data transport client, or the functionality provided by the data transport client, to be implemented in the data consumer itself. Regardless of if implemented within the data consumer 214 or as a separate component, the data transport client 208 provides similar functionality to the data transport applications 206.

In particular, it includes a data consumer interface 224 for communicating with the data consumer 214, a message processor 226 for processing received messages and a data broker engine interface 228 for communicating with the data broker engine 202.

A model management client 210 may also be provided. The model management client 210 includes a data broker engine interface 230 for communicating with the data broker engine 202. The model management client 210 may provide functionality for managing a model of the data broker system. For example, the model management client 210 may be used to link pieces of data together within the model, as described further below.

As described above, one or more data consumers can request data from the data broker engine 202. The request and response messages may be sent using the data service bus functionality 204. The messages are received and processed by the data broker engine 202. The data broker engine 202 includes a message queue 232 where new messages are received. For example, when a new request is sent from a data transport client, it is placed on the message queue. The messages of the queue are processed by a message processor 234 which may determine the type of message and pass it to an appropriate message handler for the message type. The message processor 234 may also provide other functionality such as verification, authentication and authorization functions. The messages may be processed to verify that they conform to an expected format. Messages may also be authenticated in order to authenticate the sender of the message and determine if the sender is authorized to send the particular message.

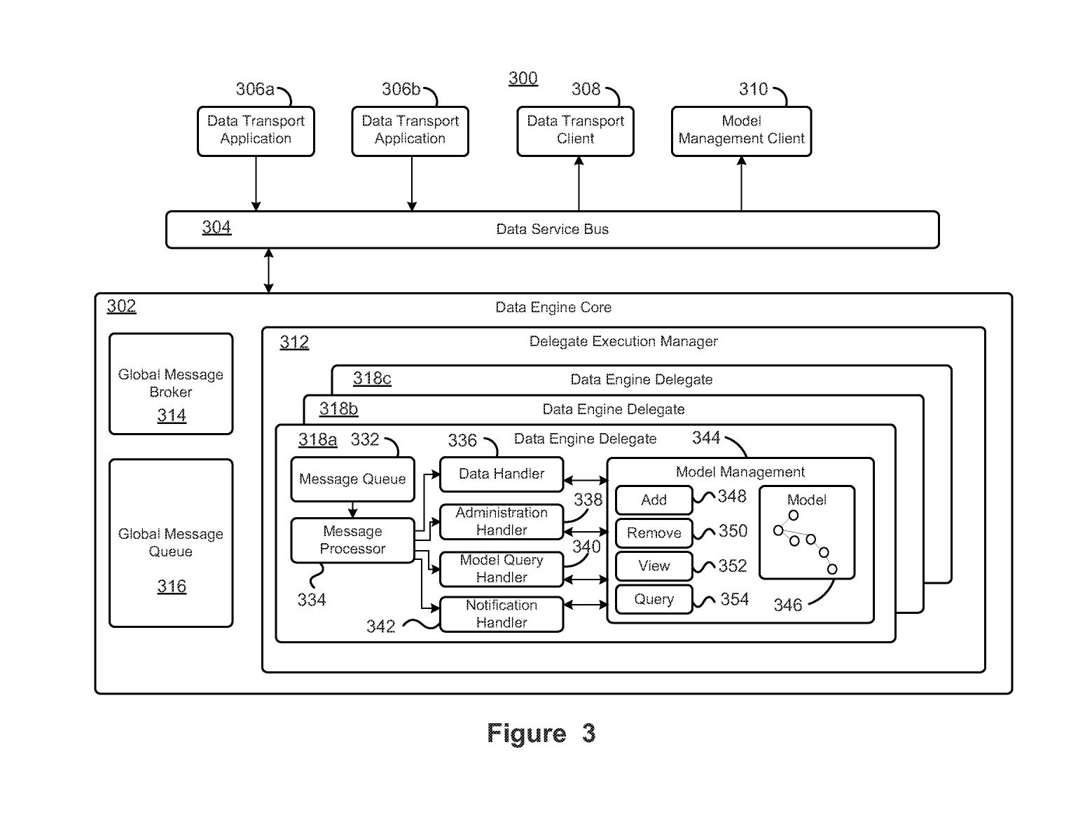

The message processor 234 may pass messages from the message queue to a particular message handler based on the message type. As depicted, the data broker engine 202 may include a data request handler 236, an administration control handler 238, a model query handler 240 and a notification handler 242. Each of the handlers may access model management functionality 244 that maintains a model 246 of the available data that the data broker can access. The model comprises data request definitions and transformation definitions to enable data to be associated and retrieved from data providers based upon a received data request message. The particular handlers 236, 238, 240, 242 are described in further detail following the description of FIG. 3.

The data model 246 describes available data provided by each of the plurality of data providers that have registered with the data broker engine 202 and the data requests for retrieving available data from the data providers. Each of the data requests includes at least one parameter specification required by the respective data request. The data model 246 of the data broker engine 202 may also include one or more data transformation definitions each for linking a piece of data from the available data of one of the plurality of data providers to a corresponding piece of data of the available data of another of the plurality of data providers and data request definitions defining how the data can be requested from the data provider in regards to available parameters, inquiry formatting, communication protocols and data conversions. The data model 246 may be updated as data providers register with the data broker engine 202, or are un-registered from the data broker engine 202. The data model 246 comprises data definitions 260, data request definitions 262, and transformation definitions 264. When registering with the data broker engine 202, the data provider provides the model of the data provider, such as model 222a, 222b, which may be used to add the data provided by the data provider to the data broker engine's model 246. The model management 244 may include functionality 248 for adding or modifying a portion of the model 246, functionality 250 for removing a portion of the model 246, functionality 252 for viewing a portion of the model 246 as well as functionality 254 for querying the model 246.

FIG. 3 depicts components of a high-availability data brokering system. The system 300 is similar to the system 200 described above, and as such, similar components are not described in further detail. As with the system 200 described above with reference to FIG. 2, the system 300 comprises a data broker engine 302 connected to one or more of a plurality of components, including data transport applications 306a, 306b, a data transport client 308 and a model management client 310. The components may be coupled together through a data service bus 304. Similar to the data broker engine 202, the data engine core 302 allows data to be provided to data transport clients 308 from different data transport applications. However, in contrast to the data broker engine 202, the data engine core 302 comprises a delegate execution manager 312, which comprises a plurality of individual data engine delegates 318a, 318b, and 318c (referred to collectively as data engine delegates 318). The data engine delegates 318 provide substantially similar functionality as the individual data broker engine 202 described above. However, the plurality of data engine delegates 318 allows for redundancy and load balancing. The data engine core 302 further includes a global message queue 314 and a global message broker 316.

The global message queue 314 receives messages from components coupled to the data service bus 304. The messages are temporarily stored on the global message queue 314 until they are processed by the global message broker 316. The global message broker 316 processes messages from the queue and directs the message to one or more of the data broker engine delegates 318. The global message broker 316 passes the message from the global message queue 314 to the message queue 232 of a respective data broker engine delegate. Data request messages received from a data transport client 308 may be passed to a single data broker engine delegate for processing. Once a message has been provided to a respective data broker engine delegate 318, further messages associated with processing the received message may be sent directly to the message queue 232 of the data broker engine delegate.

In order to maintain a consistent data model 246 across each of the data broker engine delegates 318, messages that modify the data model may be passed to each of the data broker engine delegates 318. For example, when one data broker engine delegate registers a new data transport application, it will receive data model information of the information available from the data transport application. The data broker engine delegate will update its data model 346 using the model management functionality 344 with the received data model information, defining data definitions, data request definitions and transformation definitions and can forward the data model information onto each of the other data broker engine delegates 318 for adding to the respective data models.

Turning to the components of the data engine core 302 and the data broker engine delegates 318, each comprises a number of handlers 336, 338, 340, 342 that handle processing different types of messages or requests. The handlers include a data request handler 336 that processes requests for data from data transport clients 308. The processing of the data requests may include determining from the data model a chain of data requests and associated data request definitions that will provide the requested data based on at least one parameter given in the data request. Determining the chain of requests may be done recursively, starting with the request that returns the requested data and ending with a request that requires the provided parameters. The data request handler 336 may further transform the received data in order to provide it to the requesting data transport client 308. The data may be returned in a number of different formats. For example, data may be returned in a JSON format or XML format according to a particular schema, or other types of formats that may be negotiated and agreed upon between components.

An administration handler 338 may receive and process administration messages. The administration messages may include, for example, adding users, changing security settings, registering data transport applications, removing data transport applications, registering data transport clients, removing data transport clients as well as performing other administrative tasks. The administrative handler 338 may access the data model, for example in order to change access authorization information associated with accessing available data provided by one or more data transport applications.

A model query handler 340 may receive and process queries to the data model. The model queries may be received directly from a connected component, for example requesting a model of the available data from the data transport applications. In addition to processing model queries received from connected components, the model query handler 340 may also process query request from internal components of the data engine core 302 or the data broker engine delegates 318. For example, the model query handler 340 may process queries of the model from the data request handler 336, the administration handler 338 and the notification handler 342. The queries to the model management may include requests for adding new data to the model, modifying existing data of the model as well as removing existing data from the model.

A notification handler 342 may receive and process notification requests. The notification requests may be received from a data transport client that is registering to receive particular data published or provided by one or more of the data transport applications. The notification handler may determine if the data subscribed to by the user can be provided by a data transport application that allows for registering to data notifications. If notifications of data can be provided, the notification handler subscribes to the requested data. If the notifications of the data cannot be provided, the notification handler 342 may create one or more polling events for periodically requesting the data in order to provide the notification service.

Model management functionality 344 allows the data engine delegate to modify, query and view the data model 346. Although various functionality can be provided by the model management functionality 344, there is depicted functionality for adding data or to the data model 348, removing data from the data model 350, viewing the data model or portion of the data model 352 and querying the data model 354.

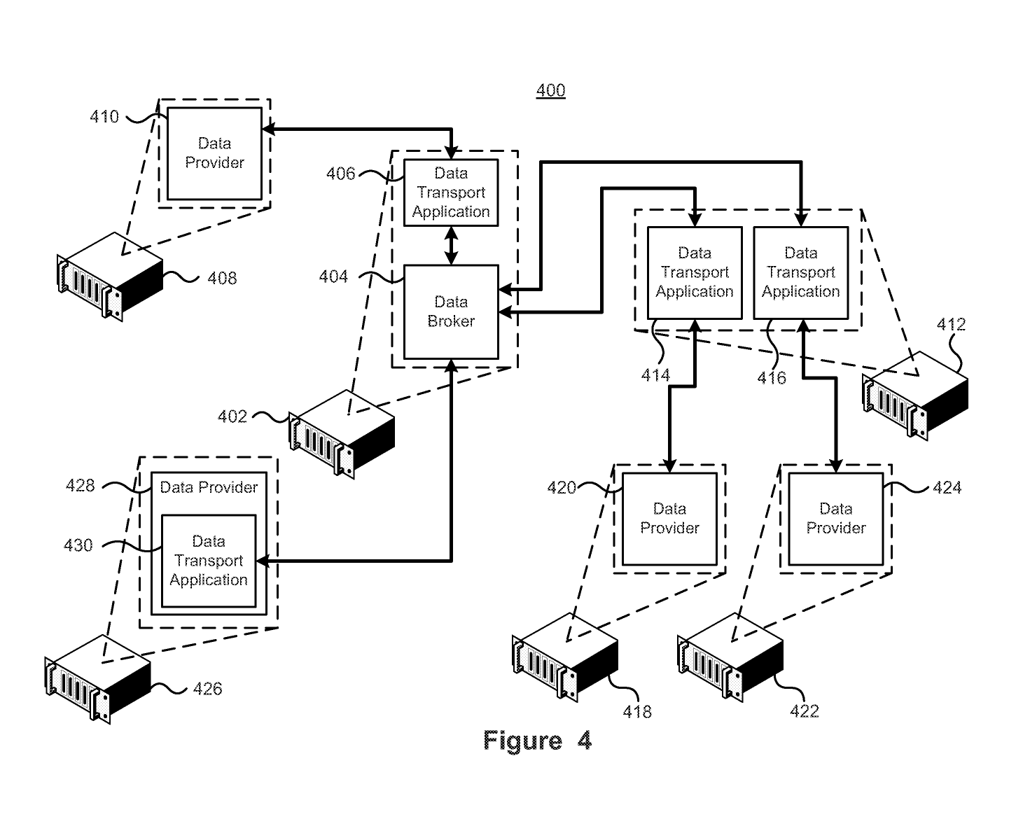

FIG. 4 depicts an environment that may implement a data broker system as described above. The environment 400 is depicted as comprising a number of different servers that are interconnected by one or more networks (not shown). Each server is depicted as implemented on or more components for providing data to the data provider. As described above, a data broker may receive data from a plurality of different data providers through an associated data transport application. A server 402 may provider a data broker 404 that is connected to other components. The server 402 may also provide a data transport application 406. The data transport application 406 may receive data from a data provider 410 implemented on a separate server 408. Another server 412 is depicted as providing two data transport applications 414, 416 that communicate with the data broker 404. Each of the data transport applications 414, 416 may receive data from respective data providers 420, 424 implemented on separate servers 418, 422. Another server 426 is depicted as providing a data provider 428 that incorporates the data transport application functionality 430. Although particular implementations are depicted in FIG. 4, not all possible implementations are depicted. For example, a single data broker 404 is depicted; however, it is possible to provide numerous data brokers, or data broker delegates on separately located servers. Further, multiple data providers may be provided on the same server along with multiple data transport applications.

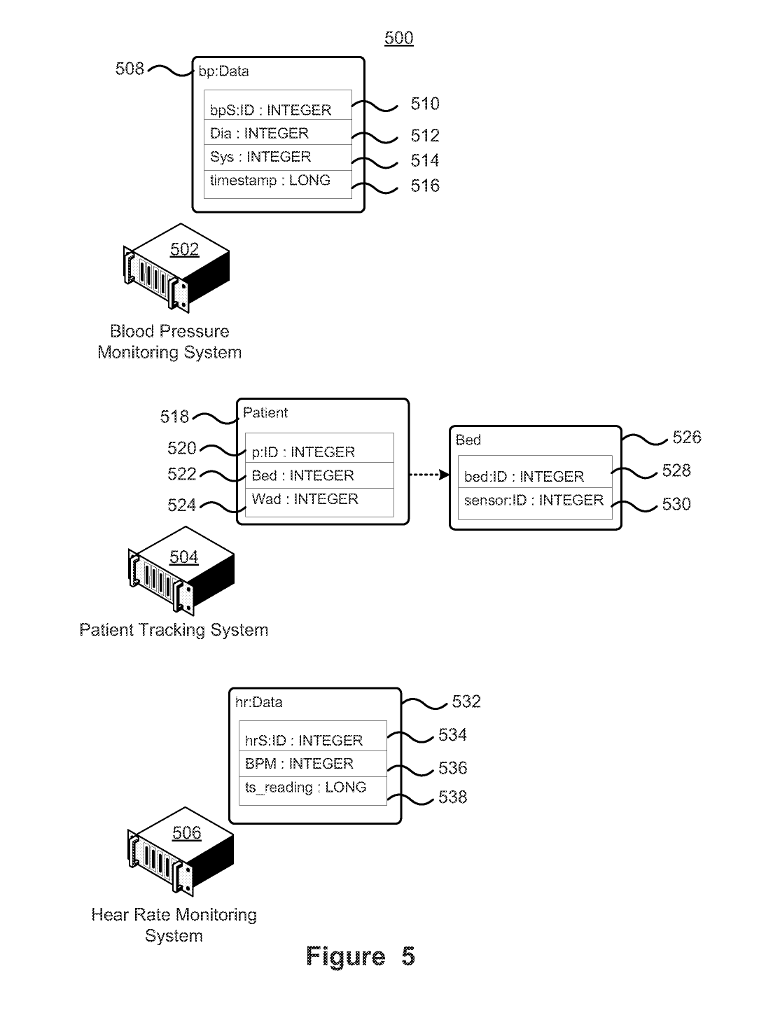

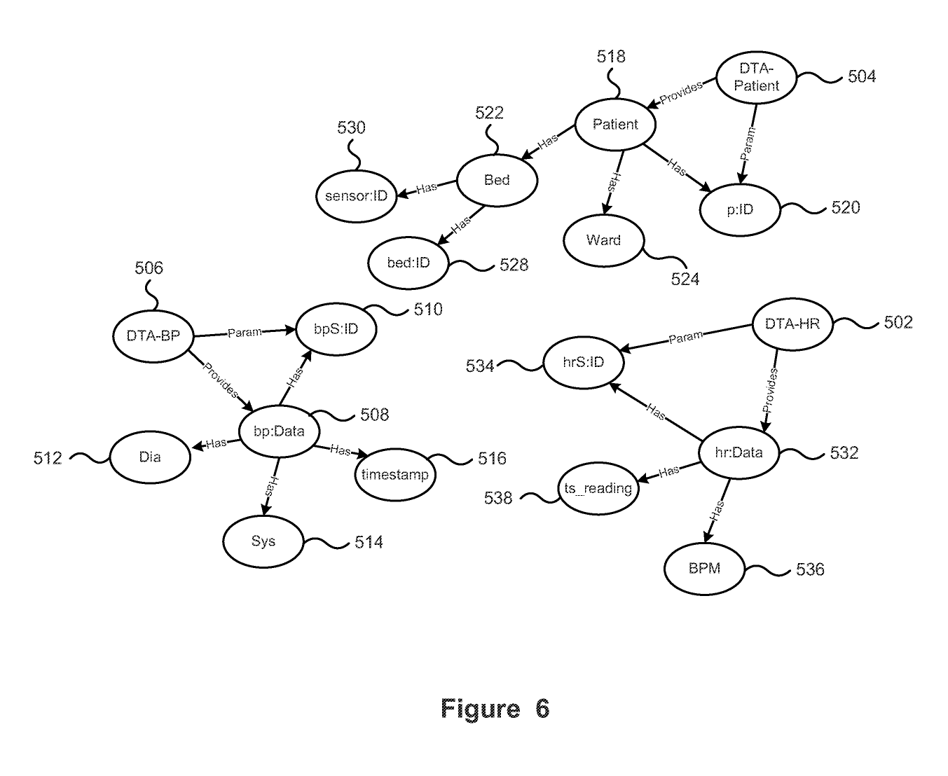

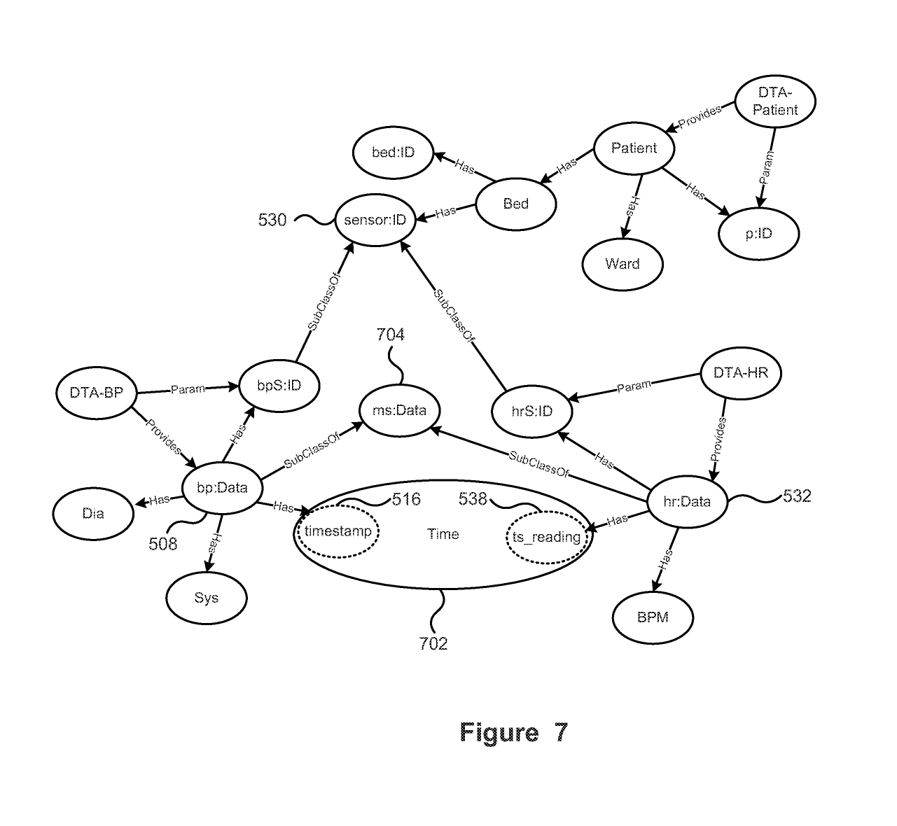

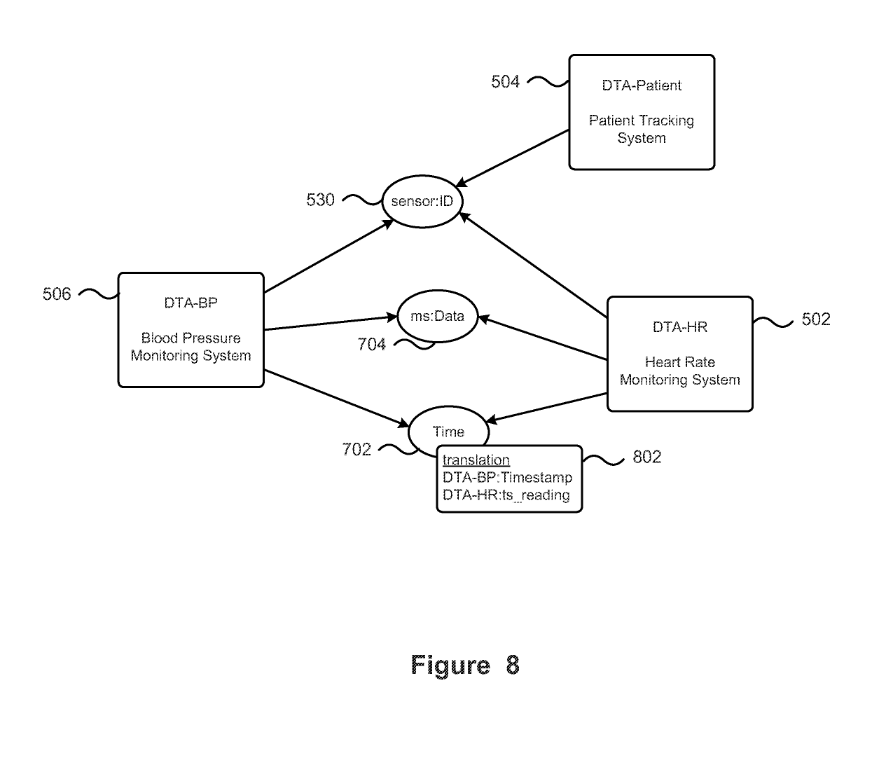

FIG. 5 depicts an example of data provided by different systems in a medical environment. FIG. 6 depicts a model of the data provided by the different systems. FIG. 7 depicts a combined model of the data provided by the different systems. FIG. 8 depicts a simplified view of the data model of FIG. 7. The model of data provided by different systems is described further with reference to FIGS. 5 to 8. The data model provides data definitions associated with each of the data providers and data request definitions are provided for defining how to retrieve available data from the data providers are used to format request to the respective data provider. Each data request definition specifying at least one required parameter for fulfilling a data request by associated with the respective data request definition. One or more data transformation definitions are provided in the model to specify transformations between respective available data definitions of different data providers for corresponding data. The data request definitions may be explicitly defined within the data model or may be implicitly defined based upon the data and relationships between data according to an agreed upon request format within the data model.

As depicted in FIG. 5, a number of different systems provide data. The systems can include for example computing devices such as a blood pressure monitoring system 502, a patient tracking system 504 and a heart rate monitoring system 506. The blood pressure monitoring system 502 provides access to blood pressure sensors. Each blood pressure sensor is associated with a unique identifier. The system 502 may be individual monitors or provided by a collection system. In a hospital environment, the blood pressure sensors may be associated with a particular bed or assigned to a patient. The patient tracking system 504 may include information on what patient is located in which bed, as well as what sensors are associated with the beds. The heart rate monitoring system 506 provides heart rate information from heart rate sensors.

As depicted, the blood pressure monitoring system 502 provides blood pressure data (bp:Data) 508 comprising an ID of the sensor 510, a diastolic reading (Dia) 512, a systolic reading (Sys) 514 and a timestamp 516 the readings were recorded. The patient tracking system 504 provides patient data 518 and bed data 526. The patient data 518 comprises a patient ID (p:ID) 520, a bed identifier (Bed) 522 of the bed the patient is in and a ward (Wad) 524 that the patient is in. The bed information 526 comprises a bed identifier (bed:ID) 528 and a sensor ID (sensor:ID) 530 of a sensor associated with the bed. The heart rate monitoring system 506 comprises heart rate data (hr:Data) 532 comprising a sensor identifier (hrS:ID) 534, a blood pressure reading (BPM) 536 and a timestamp (ts_reading) 538 the reading was taken at.

Each of the systems 502, 504, 506 may provide an interface for requesting information from the system. Although not depicted in FIG. 5, the systems may describe the operations for accessing data. For example, the blood pressure monitoring system 502 may provide blood pressure readings for a given sensor ID. The request may specify the sensor ID as well as a time frame for the desired data. The patient tracking system may return associated bed information for a particular patient ID. The heart rate monitoring system 506 may provide heart rate information 532 for a provided sensor ID.

FIG. 6 depicts graphically the data provided by each system. As depicted, each of the systems provides various data. The data models provided by each of the systems are graphically depicted. The actual data models may be specified in various ways including various languages for describing data models. As depicted in FIG. 6 each of the data systems 504, 506, 508 may provide data based on at least a particular parameter. For the data transport application of the patient tracking system 504, the system provides patient data 518 given a patient ID 520 as a parameter. The patient data 518 has bed data, which in turn has a sensor ID 530 and bed ID 528. The patient data 518 also has ward information 524 as well as the patient ID 520.

The data transport application for the blood pressure system 506 provides blood pressure data 508 when a blood pressure sensor ID 510 is passed as a parameter. In addition to the blood pressure sensor ID, the blood pressure sensor data includes the diastolic reading 512, the systolic reading 514 as well as the timestamp 516.

The data transport application for the heart rate system 502 provides the heart rate data 532 when a heart rate sensor ID 534 is provided as a parameter. The heart rate data 532 comprises a heart rate sensor ID 534, a blood pressure reading (BPM) 536 and a time stamp (ts_reading) 538.

As depicted in FIG. 7, the data model may be manipulated, for example using a model management client 210 and model management functionality 244 of the data broker engine 202. As depicted in FIG. 6, the heart rate data and the blood pressure data each have a timestamp associated with each reading. However, each timestamp is identified using different names. Accordingly, without further information, it would not be possible to, for example, identify heart rate data that occurred at the same time as a particular blood pressure reading. The model may be modified by identifying corresponding data. In particular, the timestamp 516 and the ts_reading 538 may be identified as corresponding data and a transformation definition 702 between the two pieces of data can be added to the data model. In addition to translating corresponding information, the model may be modified in order to add information pertaining to relationships between data. For example, the blood pressure sensor ids and hear rate sensor IDs may be indicated as being a subclasses of sensor IDs. Similarly, additional class information may be added to the model. For example, a measurement sensor data (ms:Data) class 704 may be added and the blood pressure data 508 and the heart rate data 532 may be identified as subclasses of the ms:Data. By identifying relationships in the model, it is possible to provide expanded capabilities of the system. For example, with the blood pressure data and the heart rate data identified as subclasses of ms:Data, it is possible to request all ms:Data 704 associated with a particular patient. The data broker engine will determine the bed associated with the patient and all of the sensor IDs associated with the bed and then return the blood pressure and heart rate data. If a new sensor system is added, for example an oxygen sensor system, a client requesting the ms:Data would receive the updated sensor data without changing the request.

FIG. 8 depicts a simplified graphical view of the data model. As depicted, the different data transport applications 502, 504, 506 and their data may be depicted as single elements. The data common to one or more of the data transport applications 502, 504, 506 such as the sensor:ID 530, the ms:Data 704 and the time 702 may also be displayed. The model may be manipulated, by for example, clicking on one of the data transport application representations may expand the representation to depict the individual data provided by the system. Additionally, translation information linking two or more corresponding pieces of data may be shown. As depicted, the translation information 802 may specific two or more pieces of data that correspond to each other. Additionally, the translation information may include information for converting corresponding data between two different formats.

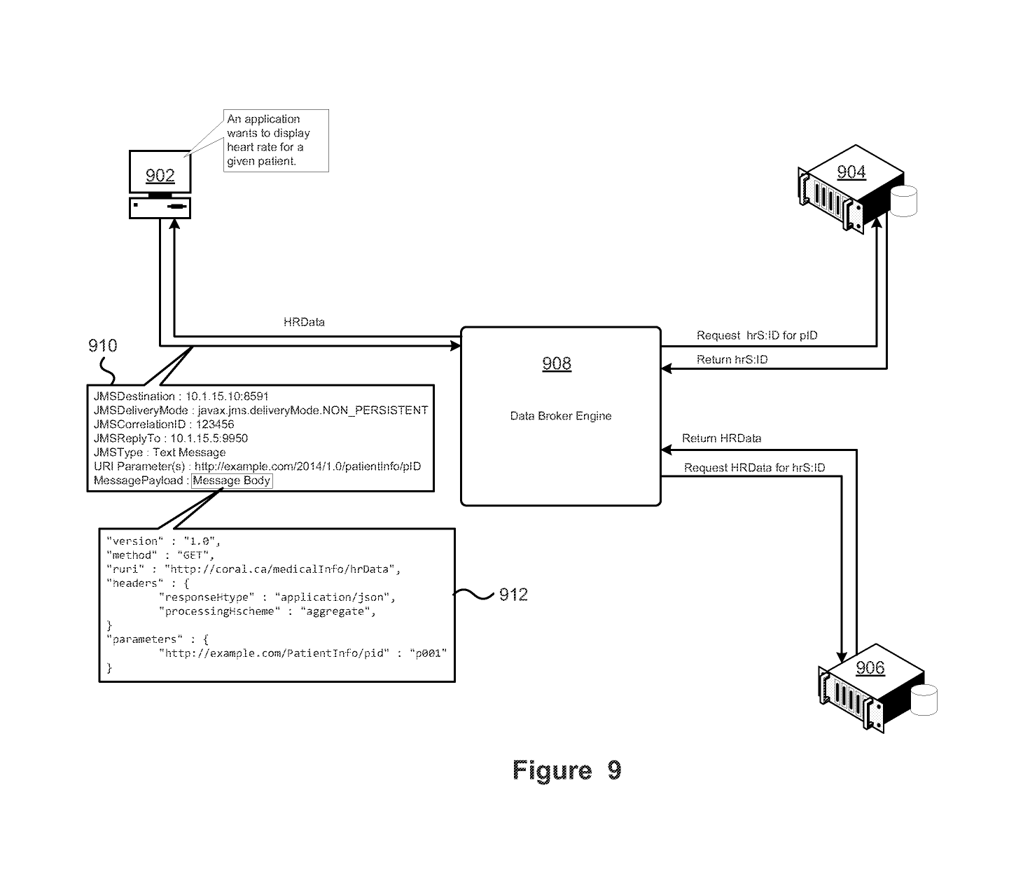

FIG. 9 depicts a process of brokering data between different systems. The system 900 includes a data transport client application 902 that provides functionality for viewing data. The data may be provided by a number of systems including a heart rate system 904 and a blood pressure system 906. The data is provided from the data provider systems 904, 906 to a data broker engine 908. The data transport client 902 may request data by sending a message 910 to the data broker engine 908. The message may specify various information segments including a message type indicating that the message is a text message. The message body 912 may indicate that the message is a GET request and specify other relevant information, including a resource uniform resource identifier (RURI) for retrieving the desired information, a response type of the request as well as a processing scheme for how to process responses. The message body may also specify one or more parameters.

The message 910 is received at the data broker engine 908 and processed to determine what requests are required in order to provide the requested data. The data broker engine 908 determines that the data request requires requesting the heart rate sensor data; however, in order to request the heart rate sensor data, the sensor ID for the particular sensor is required, and it was not provided in the request. The data broker determines that the sensor ID can be returned from the patient system 904 if the patient ID is provided and uses the associated data request definition to request the data from the patient system 904. Accordingly, the data broker system 908 determines the data formation from the data definition and a data request definition for retrieving the heart rate sensor ID for the specified patient ID and receives the resultant sensor ID from the patient system 904. A transformation definition can then be utilized to map data formatting and the sensor ID to the respective blood pressure system 906. The data broker engine than uses the sensor ID to request the heart rate sensor data for the sensor ID using a respective data request definition for the blood pressure system 906. The heart rate sensor data is received by the data broker engine and formatted into a response which is returned to the requesting system 902 using the transformation definitions between the systems.

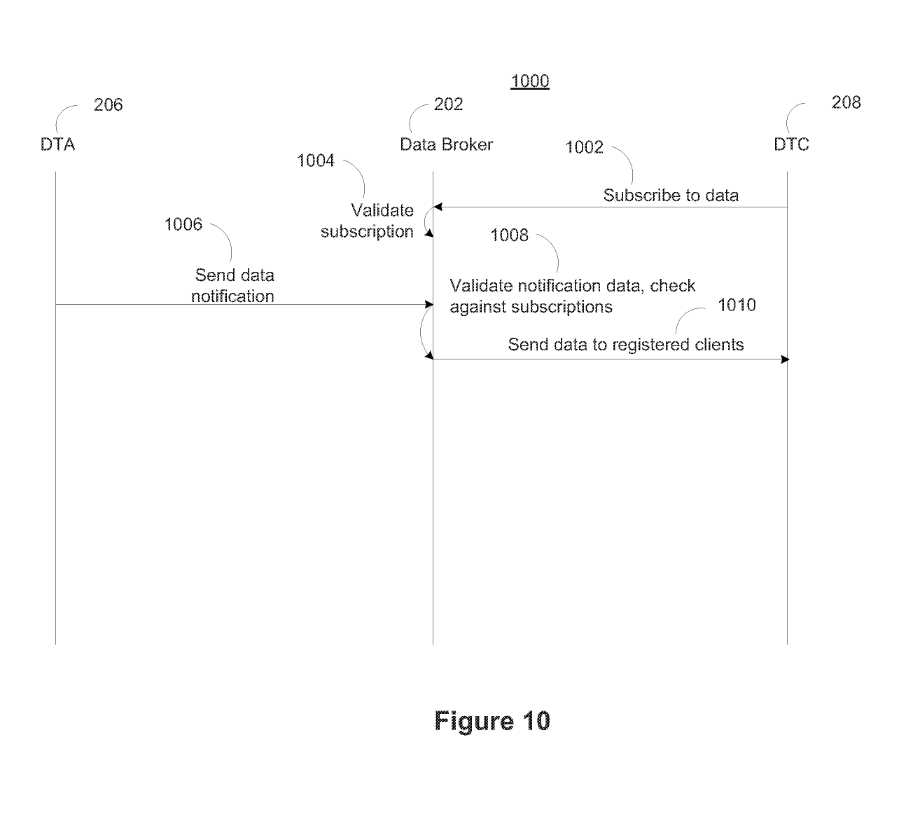

FIG. 10 depicts a process for subscribing to data. The process 1000 begins with a data transport client 208 subscribing to available data 1002. The subscription message is validated 1004, which may include validating that the requested data is available in the model ontology and possibly validating that the requesting client is authorized to access the requested data. At some point after receiving the subscription request, the data broker system receives notification of the requested data 1006. The received data may be validated and checked against the data subscriptions 1008, and sent to any data transport clients that have subscribed to the data 1010. If the desired data, that is the data subscribed to, needs a parameter from another system that may change periodically, the subscription can be periodically refreshed so that any change in the parameter will be reflected in the subscribed to data. Alternatively, when the subscribed to data is received, the entire request chain may be validated to ensure that the correct data was provided. If the parameters have changed, the subscription can be updated to reflect the new parameter and new subscription data received. Further still, if subscription data requires a parameter that may change, a thread or delegate may be provided for periodically monitoring the parameter for a change, if the parameter changes, the subscription can be updated accordingly.

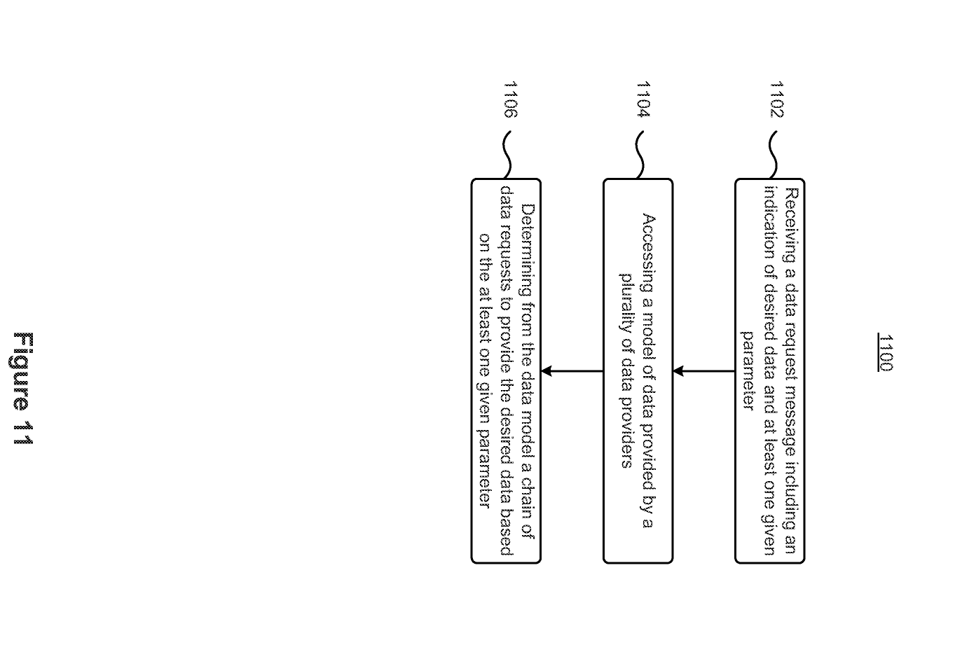

FIG. 11 depicts a method of brokering data exchange between multiple data providers. As described above, a plurality of different data providers may each provide data that can be used in retrieving requested data. As depicted in FIG. 11, the method 1100 receives a data request message including a data indicator specifying desired data and at least one given parameter (1102). As described above, the indicator of the desired data specifies at least one data element within a data model that describes the data provided by the different data providers. Once the data request message is received, the model of the data is accessed (1104). As described above the data model describes available data provided by each of the plurality of data providers as well as defining the data requests for retrieving available data from the data providers. Each data request definition includes at least one parameter specification required by the respective data request for use in retrieving the data. The data model further describes one or more data transformation definitions, each data transformation definition is for linking available data from one of the plurality of data providers to corresponding data of the available data of another of the plurality of data providers. The accessed data model is used in determining a chain of data requests to each of the plurality of data providers that will provide the desired data based on the at least one given parameter (1106) received in the data request message. The chain of data requests can be sent to the respective data providers in the required order to obtain the requested data by the data broker. In some situations the data requests may be sent simultaneously to multiple systems if the data requested is not dependent on a result of the another data provider, however they requests are chained when information cannot be necessarily obtained without receiving information from a previous data provider. The result of the data requests can then be returned to the data requester.

Although the above discloses example methods, apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods and apparatus, persons having ordinary skills in the art will readily appreciate that the examples provided are not the only way to implement such method and apparatus. For example, the methods may be implemented in one or more pieces of computer hardware, including processors and microprocessors, Application Specific Integrated Circuits (ASICs) or other hardware components.

The present disclosure has described various systems and methods with regard to one or more embodiments. However, it will be apparent to persons skilled in the art that a number of variations and modifications can be made without departing from the teachings of the present disclosure

What is claimed is:

1. A method of brokering data comprising:
receiving a data request message at a data broker system communicatively coupled to a plurality of data providers, the data request message comprising a data indicator specifying desired data and at least one given parameter for use in retrieving the desired data;
accessing a data model of data provided by the plurality of data providers, the data model describing:
available data definitions specifying data provided by each of the plurality of data providers;
data request definitions for retrieving available data from the plurality of data providers, each data request definition specifying at least one required parameter for fulfilling a data request by associated with the respective data request definition; and
one or more data transformation definitions specifying transformations between respective available data definitions of different data providers for corresponding data; and
determining from the data model a chain of data requests to one or more data providers of the plurality of data providers to provide the desired data based on the at least one given parameter.

2. The method of claim 1, further comprising:
requesting the desired data according to the determined chain of data requests;
receiving the desired data from at least one of the plurality of data providers; and
formatting and returning the desired data in response to the received data request message.

3. The method of claim 1, wherein one or more of the available data definitions comprise a unique data identifier associated with the data provided by the respective data provider.

4. The method of claim 3, wherein one or more of the available data definitions further comprise:
a type description describing a variable type of the associated data provided by the data provider;
a description of the associated data provided by the respective data provider; and
one or more restrictions on the associated data.

5. The method of claim 1, wherein one or more of data request definitions comprise:
a unique operation identifier;
an input data definition of at least one available data definition that the respective data request requires as the required parameter; and
an output data definition of at least one available data definition that the respective data request returns.

6. The method of claim 1, wherein one or more of the data transformations comprise:
an identification of two or more available data definitions associated with the corresponding data; and
a mapping between the two or more the two or more available data definitions.

7. The method of claim 1, wherein the data indicator of the received data request message comprises an identifier of at least one available data definition in the data model.

8. The method of claim 1, wherein the chain of data requests comprises a plurality of data request definitions from the data model, with a first data request definition of the plurality of data request definitions comprising a data request definition having the at least one required parameter corresponding to the at least one given parameter of the received data request message, and a second data request definition of the plurality of data request definitions comprising a data request definition for retrieving available data corresponding to the desired data specified by the data indicator of the received data request message.

9. The method of claim 8, wherein the chain of data requests further comprises a plurality of linking request definitions with retrieved available data of one of the plurality of additional request definitions providing one or more required parameters of a subsequent additional request definition.

10. The method of claim 1, wherein the chain of data requests comprises a plurality of data request definitions, with the at least one required parameter of one of the plurality of data request definitions provided by retrieved available data by a second one of the plurality of data request definitions, at least one or more of the data transformation definitions providing a mapping between the at least one required parameter of the one of the plurality of data request definitions provided by the retrieved available data by the second one of the plurality of data request definitions.

11. The method of claim 1, wherein the chain of data requests to provide the desired data based on the at least one given parameter is determined recursively.

12. The method of claim 1, wherein the data request message is a subscription request message for the desired data, the method further comprising subscribing to the desired data provided by the data provider.

13. The method of claim 1, wherein the data broker system comprises a plurality of data engine delegates each comprising a respective copy of the data model, the method further comprising:
determining a data engine delegate of the plurality of data engine delegates for processing of the received data request message; and
passing the received data request message to the determined data engine delegate.

14. A data broker system for brokering data exchange between a plurality of data providers communicatively coupled to the data broker system, the system comprising:
a memory unit for storing instructions; and
a processing unit configured for executing the instructions, which when executed configure the system to:
receive a data request message at a data broker system communicatively coupled to a plurality of data providers, the data request message comprising a data indicator specifying desired data and at least one given parameter for use in retrieving the desired data; and
access a data model of data provided by the plurality of data providers, the data model describing:
available data definitions specifying data provided by each of the plurality of data providers;
data request definitions for retrieving available data from the plurality of data providers, each data request definition specifying at least one required parameter for fulfilling a data request by associated with the respective data request definition; and
one or more data transformation definitions specifying transformations between respective available data definitions of different data providers for corresponding data; and
determine from the data model a chain of data requests to one or more data providers of the plurality of data providers to provide the desired data based on the at least one given parameter.

15. The data broker system of claim 14, wherein the executed instructions further configure the data broker system to:
request the desired data according to the determined chain of data requests;
receive the desired data from at least one of the plurality of data providers; and
format and return the desired data in response to the received data request message.

16. The data broker system of claim 14 wherein one or more of the available data definitions comprise a unique data identifier associated with the data provided by the respective data provider.

17. The data broker system of claim 14, wherein one or more of the available data definitions further comprise:
a type description describing a variable type of the associated data provided by the data provider;
a description of the associated data provided by the respective data provider; and
one or more restrictions on the associated data.

18. The data broker system of claim 14, wherein one or more of data request definitions comprise:
a unique operation identifier;
an input data definition of at least one available data definition that the respective data request requires as the required parameter; and
an output data definition of at least one available data definition that the respective data request returns.

19. The data broker system of claim 14, wherein one or more of the data transformations comprise:
an identification of two or more available data definitions associated with the corresponding data; and
a mapping between the two or more the two or more available data definitions.

20. The data broker system of claim 14, wherein the data indicator of the received data request message comprises an identifier of at least one available data definition in the data model.

21. The data broker system of claim 14, wherein the chain of data requests comprises a plurality of data request definitions from the data model, with a first data request definition of the plurality of data request definitions comprising a data request definition having the at least one required parameter corresponding to the at least one given parameter of the received data request message, and a second data request definition of the plurality of data request definitions comprising a data request definition for retrieving available data corresponding to the desired data specified by the data indicator of the received data request message.

22. The data broker system of claim 21, wherein the chain of data requests further comprises a plurality of linking request definitions with retrieved available data of one of the plurality of linking request definitions providing one or more required parameters of a subsequent linking request definition.

23. The data broker system of claim 14, where in the chain of data requests comprises a plurality of data request definitions, with the at least one required parameter of one of the plurality of data request definitions provided by retrieved available data by a second one of the plurality of data request definitions, at least one or more of the data transformation definitions providing a mapping between the at least one required parameter of the one of the plurality of data request definitions provided by the retrieved available data by the second one of the plurality of data request definitions.

24. The data broker system of claim 14, wherein the chain of data requests to provide the desired data based on the at least one given parameter is determined recursively.

25. The data broker system of claim 14, wherein the data request message is a subscription request message for the desired data, and wherein the executed instructions further configure the data broker system to subscribe to the desired data provided by the data provider.

26. The data broker system of claim 14, further comprising a plurality of data engine delegates each comprising a respective copy of the data model, the executed instructions further configure the data broker system to:
determine a data engine delegate of the plurality of data engine delegates for processing of the received data request message; and
pass the received data request message to the determined data engine delegate.
